(19) United States
(12) Patent Application Publication
(10) Pub. No.: US 2014/0103631 A1
(43) Pub. Date: Apr. 17, 2014

(54) REMINDER SYSTEM ASSOCIATED WITH A CONSUMER PRODUCT

(71) Applicant: The Procter & Gamble Company, Cincinnati, OH (US)

(72) Inventors: Karen Lai-Ting Chan, Villa Hills, KY (US); Jonathan Livingston Joyce, Independence, KY (US); Kirsten Louise McKillop, Cincinnati, OH (US); Kelly Lee Schmeichel, Cincinnati, OH (US); Irene Spalazzi, Mason, OH (US); Elizabeth Jane Wenzel, Wauwautosa, WI (US)

(73) Assignee: The Procter & Gamble Company, Cincinnati, OH (US)

(21) Appl. No.: 14/134,337

(22) Filed: Dec. 19, 2013

Related U.S. Application Data
(63) Continuation of application No. 13/633,146, filed on Oct. 2, 2012.

(51) Int. Cl. B42D 15/00

(52) U.S. Cl. CPC B42D 15/00
USPC 283/67

(57) ABSTRACT

A method for reminding a user to replace, use or remove a consumer product. The method comprises providing a consumer product comprising a tag associated with the product wherein the tag is decodable by a reader device and providing a reminder system wherein upon decoding the tag the reminder system prompts a user to set a reminder to use, replace, or remove a consumer product.

### FIELD OF THE INVENTION

The present invention is generally related to a reminder system associated with a consumer product.

### BACKGROUND OF THE INVENTION

When using consumer products, users frequently do not get the optimum benefit from the products because they are not using the products properly. One reason for this is because consumers forget to use, remove or replace the product. In other instances, the user ignores the package instructions, does not understand the package instructions or does not follow the package instructions which ultimately results in suboptimum benefits from the products.

For instance, in the case of multi-symptom relief cold/flu medicine users miss doses or wait too long to take subsequent doses, which results in their cold symptoms returning and the user feeling more ill. In another example, users neglect to change their razor blade when it becomes dull, resulting in a rougher shave as well as more nicks, bumps, and irritation while shaving. And in another example, users forget to change their feminine pad or tampon which results in leaking, which can be uncomfortable, can stain clothing, and can be embarrassing.

Another reason consumers do not get the optimum benefit from consumer products is that they are unsure when to replace or use the product. For example, over a prolonged period of use a consumer may not realize that her razor blade is dull.

There is a need for an easy to use reminder system that reminds users when to use, remove or replace a consumer product.

### SUMMARY OF THE INVENTION

A method comprising the steps of: (a) providing a consumer product comprising a tag associated with the product wherein the tag is decodable by a reader device; (b) providing a reminder system wherein upon decoding the tag the reminder system prompts a user to set a reminder to use, replace, or remove a consumer product.

A reminder system comprising: (a) a consumer product comprising a tag associated with the product wherein the tag is decodable by a reader device; (b) a means for setting a time interval; and (c) a means for sending a reminder after the time interval has elapsed.

A packaged consumer product comprising: (a) a consumer product; (b) optionally a primary package; (c) a secondary container; (d) a first tag associated with the consumer product or the primary packaging; (e) a second tag associated with the secondary container.

### BRIEF DESCRIPTION OF THE DRAWINGS

While the specification concludes with claims particularly pointing out and distinctly claiming the subject matter of the present invention, it is believed that the invention can be more readily understood from the following description taken in connection with the accompanying drawings, in which:

FIG. 1A shows a wrapper of a tampon with a tag;

FIG. 1B shows a blister card with a tag;

FIG. 1C shows a battery with a tag;

FIG. 1D shows a laundry detergent container with a tag;

FIG. 2 shows a flowchart of a reminder system;

FIG. 3 shows a flowchart of an opt-in method that allows a user to opt-in to another system or method used for reminding users to use, replace, or remove a consumer product;

FIG. 4 shows a flowchart for a system or method for collecting and utilizing data collected from a reminder system to improve the performance of the consumer product and remind the user to repurchase the product;

FIG. 5 shows a flowchart for a system or method for collecting and utilizing data from a reminder system to provide the user with additional information;

FIG. 6A shows a representative screenshot of with various software application icons shown on the screen;

FIG. 6B shows a representative screenshot of the home page for the feminine hygiene removal/replacement reminder system;

FIG. 6C shows a representative screen shot for an opt-in routine;

FIG. 6D shows a representative screenshot of a code scanner;

FIG. 6E shows a representative screenshot of the main navigation page of the reminder system;

FIG. 6F shows a representative screenshot of a change timer that can be adjusted by the user;

FIG. 6G shows a representative screenshot of a means where the user can adjust the notification mode;

FIG. 6H shows a representative screenshot of a visual reminder to the consumer that it is time to change her feminine hygiene product;

FIG. 6I shows a representative screenshot of a means that allows a user to provide product performance feedback directly back to the consumer product manufacturer;

FIG. 6J shows a representative screenshot where the system plots menstrual period flow patterns based on tampon change frequency and where the system has a means to email the information to the user's gynecologist;

FIG. 6K shows a representative screenshot where the system predicts the next likely period start date and duration;

FIG. 6L depicts a representative screenshot that provides links to websites that provide additional information on feminine hygiene products and other feminine health concerns; and

FIG. 6M is a representative screenshot of a feature that alerts the user when it is time to buy more consumer products.

### DETAILED DESCRIPTION OF THE INVENTION

The present invention relates to a system that helps users remove, use or replace a consumer product. A reader device, such as a camera on a smart phone, can be used to scan a tag. The tag can be associated with the consumer product. In one example, the tag can be proximal to the consumer product when it is in use, for instance, the tag might be on the secondary container that holds the consumer product, on the primary container that holds the product, on the consumer product itself, or on an object associated with the consumer product. After scanning the tag, the information in the tag can be decoded and the user can be directed to a reminder system that assists the user in setting up a reminder. The reminder system can be a website or it can be an application. The reminder system can then assist the user in setting a reminder. In one example, the system can set the reminder automatically, in another example the user can input the time period she wants to elapse before she is sent a reminder, and in another example the system can ask the user for data to determine how long to set the reminder. The user can choose how she wants to receive the reminder, for instance, the user can receive the reminder in a text message, a phone call, an e-mail, an alert from a social networking website, the system can upload the reminder into a calendar program, and combinations thereof. By receiving a reminder to use, replace or remove a consumer product, the user can be more likely to use the product correctly and have a better usage experience.

As used herein, “application” or “app” refers to computer software that is designed to help the user perform one or more specific tasks. In one example, the application can be on a mobile computing device.

As used herein, “associated with” refers to being closely connected to. In one example, the tag is associated with the consumer product because it is located on the consumer product. In another example the tag can be on primary packaging for the consumer product. In another example, the tag can be on the secondary packaging for a consumer product and in another example the tag can be on a second consumer product that can be used with the consumer product.

As used herein, “consumer product” refers to an article, or component part thereof, produced or distributed that is designed for personal, family, or household use. In one example the consumer product can be a disposable consumer product.

As used herein, “disposable consumer product” refers to any consumer product that can be used or consumed by consumers over a relatively short period of time and are typically repurchased at regular intervals. Non-limiting examples of disposable consumer products can include absorbent products such as diapers, sanitary napkins, tampons, pessaries, adult incontinence products, toilet paper, paper towels, facial tissues, and napkins, beauty care products such as shampoos, conditioners, hair colorants, facial cleansers, pre-shaves, razor blades, shaving lotions, shaving gels, aftershaves, body wash, body lotions, cosmetics, skin creams, deodorants and anti-perspirants, health care products such as mouthwashes, toothpaste, tooth whitening treatments, cold medicines, digestive wellness remedies, vitamins, supplements, probiotics, prebiotics, supplements, probiotics, prebiotics, vitamins, prescription drugs, and flu medicines, household care products such as laundry detergents, fabric softeners, bleaches, fabric pre-treaters, deodorizers, hard surface cleaners and sanitizers, air treatments, air refreshers, dish washing detergents, batteries, and lawn treatments, pet care products such as wet and dry foods, treats, and pet care supplements, and food and beverage products such as milk, butter and other dairy products, meats, vegetables, fruits, cereals, wines, juices, and other food items with expiration dates, or automotive consumable products such as oil, oil filters, air filters, transmission fluids, windshield washer fluid, tires, engine belts, and combinations thereof.

As used herein, “linear barcode” refers to a graphic where data is represented by varying the width and spacing of parallel lines.

As used herein, the term “mobile computing device” refers to any portable device capable of running one or more software applications. Non-limiting examples of mobile computing devices can include smartphones (e.g., iPhone® or Blackberry®), personal digital assistants, netBooks, tablet computers (e.g., an iPad®, Kindle® Fire, or HP® TouchPad™), and e-readers (e.g., Kindle® or Nook®), and combinations thereof. Mobile computing devices can be connected to the Internet and/or one or more computer networks. In one example, a mobile computing device can have a digital camera and software that can enable the device to decode tags.

As used herein, “Near Field Communication (NFC) chip” refers to a tag that allows for communication between a portable computing device equipped with NFC and an NFC chip. The NFC and NFC chip can communicate on existing radio-frequency identification (RFID) standards. In one example, the NFC and the NFC chip can be relatively close to communicate, for instance, less than 1 m, in another example less than 50 cm, in another example less than 25 cm, in another example less than 10 cm, and in another example less than 5 cm.

As used herein, “primary packaging” refers to the first packaging materials which enclose and are in contact with the consumer product. In one example, the primary package can contain one consumer product and in another example the primary package can contain more than one consumer product. In one example, the consumer products contained within the primary package can be intended for use as at the same time, for instance, a user may want to take multiple vitamins at the same time. In one example, the primary package can keep the consumer product clean and/or sanitary before use. Non-limiting examples of primary packaging can include bags, trays, cans, cartons, boxes, wrappers, blister cards, vials, bottles, jars, and combinations thereof.

As used herein, “proximal to” refers to situated close to.

As used herein, “secondary container” refers to a package that can enclose one or more consumer products. In one example, the secondary container can contain one or more primary packages. In another example, the secondary container can contain consumer products that do not have primary packaging. Non-limiting examples of secondary containers can include boxes, cartons, wrappers, bottles, jars, trays, cans, vials, jars, and combinations thereof.

As used herein, “tag” refers to a machine-readable representation of data that is attached to an object. In one example, the tag is graphic and can be read with any computing device with an optical scanner element including mobile computing devices. Non-limiting examples of tags can include linear barcodes, two-dimensional barcodes, near field communication (NFC) chips, and combinations thereof.

As used herein, “two-dimensional barcode” refers to a graphic where the data is stored in two dimensions, such as vertical and horizontal directions or in a circular direction. The two-dimensional barcode can include rectangles, dots, hexagons, and other geometric patterns. In one example, the two-dimensional code can also use color for embedding information. Non-limiting examples of two-dimensional barcodes can include CyberCodes, Data Matrices, Datastrip Codes, High Capacity Color Barcodes (HCCB), Dot Codes, EZcodes, mobile multi-colored composites (MMCC), PDF417, Quick Response (QR) Codes, ShotCodes, MaxiCodes, SPARQCodes, Snap Tags, and combinations thereof.

As used herein, “reader device” or “reader” refers to a device that is capable of detecting a tag, scanning a tag, and decoding the information. A reader device can be an optical scanner. In one example, the reader device may include a camera where the camera initially captures the two dimensional code in a picture and then runs the image through a decoding algorithm. Once decoded, the tag can provide information to the user. In one example, once decoded the tag can provide information directly to the user, direct the user to a website, or provide the user with a hyperlink that the user can select to access a website.

The present invention relates to a reminder system that reminds a user to take, use, remove or replace a consumer product.

First the user locates the tag that is associated with the consumer product. The tag can be located anywhere that allows the tag to be easily scanned. The tag can be proximal to the consumer product when the product is in use, which can make it more convenient for the user to take advantage of the benefits offered by the reminder system. The consumer product that is being used can help determine the most convenient location for the tag. For instance, on laundry detergent the tag can be located on the secondary container or the tag can be located on a second consumer product, such as an appliance used in conjunction with the consumer product, like a washer and/or a dryer. For a tampon or pad, it can be most convenient to have the tag on the primary package, which can be a wrapper, since users may not have the secondary container with them when they are using the product. In another example, like batteries, the tag can be located on the consumer product. Non-limiting examples of locations for the tag can include a wrapper, a secondary container, a separate product associated with the consumer product, directly on the consumer product, or combinations thereof.

In one example, the tag can be incorporated directly into the consumer product or packaging, thereby not adding to the cost of the product or packaging. In another example, the tag can be printed on an outer surface of a consumer product and the tag can be printed on the product using any suitable printing process. Non-limiting examples of suitable printing processes can include inkjet printing, gravure printing, flexographic printing, and the like.

Furthermore, in order for the tag to be easily and accurately scanned, the tag can be located in an area where it will not have significant defects. In one example, the tag can be located on a portion of the consumer product that is relatively flat. In another example, the tag can be located in an area of the consumer product that is not designed to fold, bend, wrinkle, or otherwise deform.

Next, the user can scan the tag. The user can scan the tag with any acceptable reader device. An acceptable reader device can be one that is capable of scanning the tag and decoding the information. In one example, a mobile computing device with a camera is used to scan and decode the tag. In one example, the mobile computing device is a smartphone. After scanning the tag, the reader device can decode the tag and direct the user to the reminder system. In another example, after scanning, if the mobile computing device does not have the necessary application the reader device can automatically direct the user to an application distribution center, (such as the Apple® App Store) that can suggest that the user downloads a particular application to the mobile computing device.

The reminder system can be on any suitable platform. In one example, the reminder system can be on a website and in another example the reminder system can be on an application.

In some examples, an application might be preferred by users. This could be for events that occur regularly, for instance multiple times per year, such as a menstrual cycle, laundry, remembering to take medications and vitamins, and the like.

In some examples, a website might be preferred by the users. This could be for events that occur infrequently, for instance, remembering to take medication to alleviate cold/flu symptoms, changing batteries in a smoke detector or other device, and the like.

In one example, the reminder system can first ask the user whether or not she would like to receive reminders and only if the user answers affirmatively, will she receive dosage reminders.

The reminder system can assist the user in setting up a reminder. In some examples, once scanned, the reminder system can automatically set the time interval that can elapse before a reminder is sent. In another example, once scanned the reminder system can let the user select the time interval to elapse before the reminder is sent. And in another example, the reminder system can collect data from the user to determine the appropriate time interval to elapse before sending a reminder. The reminder system can also have any combination of these ways to determine the amount of time elapsed before sending a reminder.

The time interval for the reminder system can be any length of time. In one example, the time interval can be 30 minutes, in another example 1 hour, in another example 90 minutes, in another example 2 hours, in another example 2.5 hours, in another example 3 hours, in another example 3.5 hours, in another example 4 hours, in another example 4.5 hours, in another example 5 hours, in another example 5.5 hours, in another example 6 hours, in another example 6.5 hours, in another example 7 hours, in another example 7.5 hours, in another example 8 hours, in another example 8.5 hours, in another example 9 hours, in another example 9.5 hours, in another example 10 hours, in another example 10.5 hours, in another example 11 hours, in another example 11.5 hours, in another example 12 hours, in another example 18 hours, in another example 24 hours, in another example 48 hours, in another example 1 week, in another example 2 weeks, in another example 4 weeks, in another example 6 weeks, in another example 8 weeks, in another example 12 weeks, in another example 1 month, in another example 2 months, in another example 3 months, in another example 4 months, in another example 5 months, in another example 6 months, in another example 7 months, in another example 8 months, in another example 9 months, in another example 10 months, in another example 11 months, and in another example annually.

The reminder system can also ask a user to select how they want to receive the reminder. Non-limiting examples of reminders can include a text message, a phone call, an e-mail, an alert from a social networking website, uploading the reminder into a calendar program (e.g., Google® Calendar, iCal™, Microsoft® Outlook®) and then the user receives an alert from the calendar program, an alert from the reminder system, setting an alarm on a mobile computing device, and combinations thereof. In one example, the reminder system can ask the user for her phone number or e-mail address, but not both in order to protect private personal information. In another example, the reminder system can allow the user to select multiple methods of receiving reminders. By receiving a reminder to use, replace or remove a consumer product, the user can be more likely to use the product correctly and have a better usage experience.

After the time interval has elapsed, the reminder system can send the user one or more reminders. After receiving the reminder the user can take action by using, replacing, or removing a consumer product.

After the reminder has been sent, the reminder system can reset to send another reminder. In one example, the reminder system can automatically reset to send a subsequent reminder. In another example, the user can opt in to receive subsequent reminders. In another example, the user can confirm that she took action in order for the reminder system to reset. This confirmation can be helpful when using a consumer product where using the product too frequently can produce negative effects, for instance using doses of medicine too close together. In another example, the reminder system can ask the user to confirm that she took action; however, the reminder system can still reset to send a subsequent reminder and maintain a reminder for the maximum amount of time the product can be used. For instance, a user could set the time interval to change a tampon for five hours, if she does not confirm that she changed her tampon after five hours, the reminder system can automatically reset the time interval for five hours as well as sending a reminder after eight hours, since eight hours is the maximum amount of time that a user in the United States is instructed to wear a tampon.

In another example, the reminder system can also enable the user to post on social media websites (e.g., Facebook® or Twitter™) if desired. In one example, the user can post about their usage experience. The posts can be automatically created by the reminder system, they can be created by the user, or they can be created by the reminder system and customized by the user.

In one example, after each reminder has been sent or all of the reminders have been sent, the user can be prompted to answer questions about the product, their usage habits, and the like. In one example, the data collected from answering these questions can be used so the reminder system can provide additional information and/or recommendations to the user to improve future usage experiences. In another example, the data collected from answering these questions can help the company selling the products to improve the consumer product and create a better usage experience.

In one example, the reminder system keeps track of how many consumer products the user has consumed. In one example, this data can be sent back to the company who manufactures the consumer product so they know how many products the users consume and can make improvements to the packaging. For example, the company could learn how many products users tend to use over a particular time period and improve the number of products that are sold together. In another example, the company could learn how many multi-symptom relief cold/flu doses a user takes with a cold. Another instance where this could be useful is if two or more variations of products are sold together, like cartons of tampons that contain various absorbencies. If a company knows how many of each variety that a user consumes, they can customize boxes for that particular user or they can adjust the proportion of each variety for sale to the general public.

Furthermore, if the reminder system keeps track of the number of products that have been used, the reminder system can know when the user is out of products and can send the user a reminder to purchase more products. In one example, the reminder to purchase more products can be sent as soon as the user consumes the last product. In another example, the reminder to purchase more products can use GPS and can send a reminder when the user is near or at a store that sells the products. In another example, the reminder to purchase new products can be sent by the reminder system at a specific time or when a specific number of products are left, which can be determined by the user. In another example, an order to purchase replacement product can be sent directly to a store or internet-based store and replacement product can be automatically shipped to a location determined by the consumer.

In another example, the reminder system can send a reminder to purchase more products before an event occurs. For instance, the reminder system can send a user a reminder to buy tampons or pads one week before her period is expected to begin. In another example, the reminder system can send the user a reminder to buy cold/flu products, such as multi-symptom relief cold/flu products, before cold/flu season begins, which is generally considered to be October in the northern hemisphere and May in the southern hemisphere.

In one example, the reminder system stores the information, such as the length of time for the time interval and the means for receiving a reminder, and defaults to these selections for subsequent uses. In another example, the reminder system does not store information and it may not store the information in order to avoid storing personal private information.

In one example, when the tag is scanned it can provide additional information about the consumer product. In one example, the tag can connect the user to a website with additional information about the consumer product or related products. In another example, the reminder system can connect the user to safety information about the product, such as drug facts, dosage instructions, and pertinent information. In another example, the reminder system can have a link that directs the user to more information about the consumer product or related products.

In another example, the reminder system can send the user coupons and other promotional items. The coupons and promotional items can be for the consumer product that the user used with the reminder system, for related products, or for other products sold by the manufacturer of the consumer product. One example of a related product could be if the reminder system was for changing a diaper, the related product could be baby wipes or baby food. Another example of a related product could be if the reminder system was for cold/flu medication, the related product could be a vitamin that helps support immunity or helps reduce the duration of a cold or facial tissues (e.g. Puffs®). Another example of a related product could be if the reminder system was for a tampon or pad the related product could be vitamins or supplements for women's health.

In another example, when the tag is scanned it can provide the user with one or more rewards. Non-limiting examples of rewards can include coupons, free consumer products, cash, donations to a charitable organization, prizes, and combinations thereof.

The tag can be associated with any consumer product. In one example, the tag can be associated with a consumer product that is intended for daily use. In one example, the tag can be associated with consumer products that are not intended for daily use. In one example, the consumer product not intended for daily use can include products that are intended to be used every-other day, in another example twice a week, in another example once a week, in another example once biweekly, in another example once a month, in another example once every three months, in another example once every six months, and in another example once every year. In another example, the tag can be associated with a consumer product that is intended for intermittent use. One example of a product that can be intended for intermittent use is a product that is intended to be used regularly, for instance daily, for a period of time, and then the user can be instructed to stop using the product for a period of time.

In one example, the packaged consumer product can contain a consumer product with a first tag associated with the consumer product and a secondary container with a second tag associated with the secondary container. In another example, the packaged consumer product can contain a consumer product contained in a primary package, a first tag associated with the consumer product or the primary package, and a secondary container with a second tag associated with the secondary container. In one example the first tag and the second tag can be the same and both tags can direct the user to the reminder system.

In another example, the first tag and the second tag can be different. In this example, the first tag can direct the user to the reminder system and the second tag can direct the user to additional information. The additional information can be on a website or in an application. If the information is in an application it can be in a different application from the reminder system or it can be in the same application as the reminder system. The information can include information about or related to the consumer product, information about the reminder system, and/or instructions on how to use and set up the reminder system. In another example, the second tag can direct the user to an application distribution center to download the application for the reminder system.

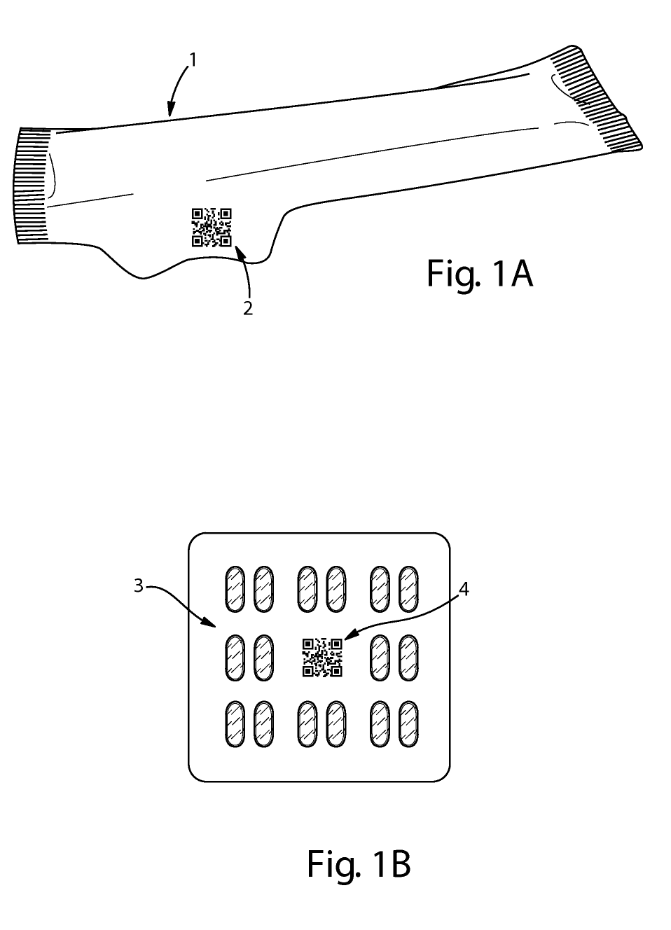

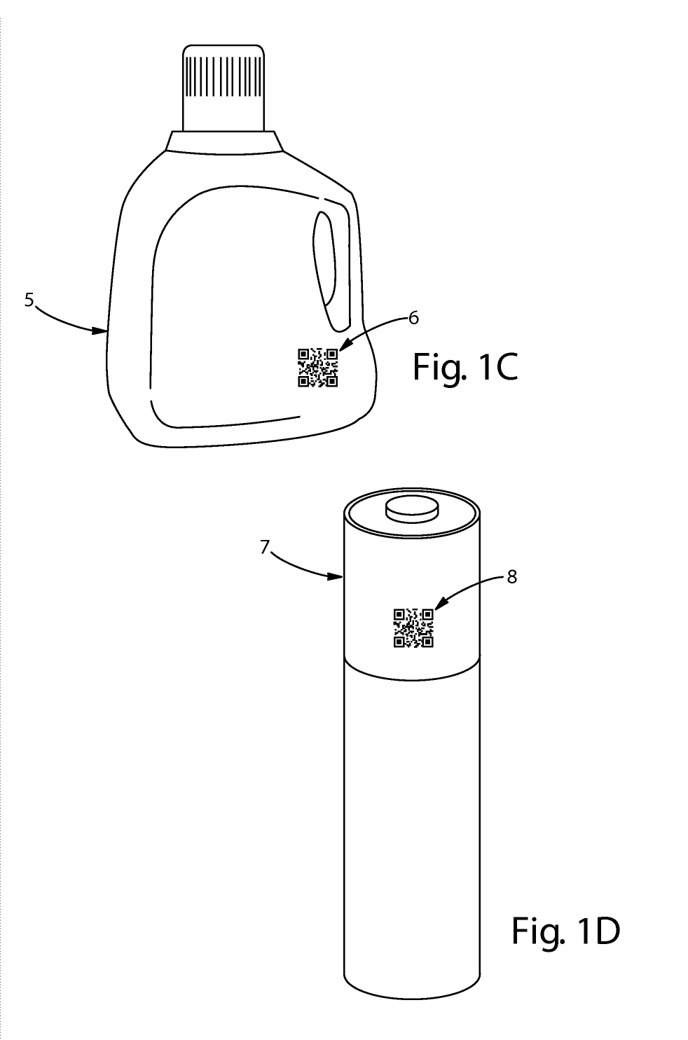

FIG. 1A shows a tampon wrapper 1 with a QR code 2. In one example, the user can scan the QR code 2 on the wrapper 1 with a reader device. After the QR code 2 is scanned, the user can be directed to a reminder system. The reminder system can assist the user in setting up a reminder to change a tampon after a time interval has elapsed. In one example, the user can select the time interval that she wants to elapse before the reminder is sent to change the tampon. In another example, the reminder system can automatically recommend a time interval to elapse before the reminder is sent between changing tampons. In another example, the reminder system can be programmed to ask the user questions such as how many days has the user had her period, how heavy is the flow, the length of time between menstrual cycles, and other questions that might help determine the appropriate time interval before the user should change their tampon and the reminder system can recommend a time interval. In one example, the time interval cannot exceed the maximum allowable time interval, for instance in the United States the maximum allowable time interval is 8 hours. In another example, the maximum time interval can be 6 hours. In one example, the tag can indicate what absorbency of tampon the user is using. In another example, the user can input into the reminder system the absorbency level of the tampon.

In another example, the tag can be associated with a maxi pad or pantiliner. The reminder system associated with a maxi pad or pantiliner can work similarly to the reminder system for a tampon. However, the eight hour maximum time interval may not be necessary with this reminder system.

FIG. 1B shows a blister card 3 with a QR code 4. In one example, the user can scan the QR code 4 on the blister card 3 with a reader device. After the QR code 4 is scanned, the user can be directed to a reminder system. The reminder system can assist the user in setting up a reminder to take medication after a time interval has elapsed. In one example, the reminder system can automatically set up the time interval for the first dose for the time recommended by a published standard, for example the U.S. Monograph which describes the approved use of pharmaceutical products. For instance, in the United States, for daytime multi-symptom relief cold/flu medicine (such as DayQuil®) the monograph recommends four hours between doses.

In one example, the blister card comprises multi-symptom relief cold/flu medicine. In another example, the blister card can comprise only daytime doses of multi-symptom relief cold/flu medicine and in another example the blister card can comprise daytime doses and nighttime doses of multi-symptom relief cold/flu medicine. In another example, the blister card can comprise three daytime doses of multi-symptom relief cold/flu medication and one nighttime dose of multi-symptom relief cold/flu medication. In another example the blister card can comprise over-the-counter (OTC) medicine, in another example the blister card can comprise vitamins, and in another example the blister card can comprise prescription medicine.

If the reminder is being used to alert a user when it is time to take the medication, it can be important for the reminder not to alert the user too soon causing the user to consume extra medication. However, users who dose regularly, according to the monographed time interval, can experience better relief of symptoms. In one example, before starting the interval, the reminder system can have the user select when the dose was consumed. For instance, the user may have taken the first dose and then immediately started the time interval or the user may have taken their first dose and waited to scan the tag and therefore he or she can input the amount of time that has elapsed and the reminder system can adjust the duration of time that the user has to wait before dosing again.

After the time interval has elapsed, the reminder system can send the user a reminder, alerting her that it is time to take her next dose. In one example, the reminder can also remind the user that it is only necessary to take the next dose if she is still experiencing symptoms. In another example, the reminder can also remind the user that they should take the next dose even if they are not feeling symptomatic. In another example, after receiving a reminder, the reminder symptom can prompt the user to enter the symptoms she experiencing and the reminder system can recommend a product. The reminder system can recommend the same product or a different product that is more suitable for the symptoms the user is experiencing. In another example, the reminder system does not send a reminder after the last dose on the blister card has been consumed, in particular if the last dose on the blister card is a nighttime dose. Instead, the reminder system can send the user a reminder to purchase more consumer products or the user can scan a second tag on a second blister card.

In another example, the reminder system can be used to reminder a user that she has taken her medication. This kind of reminder could be useful with a variety of users, in particular older patients who forget if they have taken their medication, or a caregiver who is taking care of multiple patients.

FIG. 1C shows a battery 5 with a QR code 6. In one example, the user can scan the QR code 6 on the battery 5 with a reader device. After the QR code 4 is scanned, the user can be directed to a reminder system. The reminder system can assist the user in setting up a reminder to change the batteries after a time interval has elapsed. In one example, the reminder system can be set to remind a user to change the batteries in a smoke detector. In one example, the user can select the date and/or time that the reminder is sent or the amount of time elapsed before the reminder is sent. In another example, the reminder can automatically determine the date and time to send the reminder. In one example, the reminder can automatically set to remind the user to change batteries on a specific day, such as the first day of daylight savings time and/or the end of daylight savings time.

FIG. 1D shows a secondary container 7 comprising liquid laundry detergent with a QR code 8. In one example, the user can scan the QR code 8 on the container 7 with a reader device. After the QR code 8 is scanned, the user can be directed to a reminder system. The reminder system can assist the user in setting up a reminder that the washer and/or dryer has completed its cycle. A reminder system that is associated with laundry could be useful for college students who live in dormitories or people who live in housing with shared laundry. This reminder system could also be useful for people who cannot hear when the laundry cycle is completed because the laundry is in a different area of the house, such as the basement, or they have elected to turn off the buzzer that is commonly on a washer and/or a dryer. In one example, the user can manually input the amount of time that the cycle will run. In another example, the user can select the type of cycle that she is going to run and the reminder can be set automatically. In another example, the user can select the type of washer and/or dryer that she is using and the cycle that she is running and the reminder can be set automatically. In another example, the washer and/or dryer can have a tag. In one example, the information regarding the type of washer and/or dryer can be stored in the reminder system, which can make it simpler and faster to set the reminder in the future.

In another example, the tag can be associated with fabric care products such as fabric softeners, bleach, dryer sheets, powdered laundry detergent, unit dose laundry detergent (such as Tide® Pods), in wash boosters (e.g., Downy® Unstoppables® and Tide® Boost™), dryer bar (e.g. Bounce® Dryer Bar), and the like. The reminder system associated with the tag can work similarly to the reminder system for liquid laundry detergent.

In one example the tag can be associated with dishwashing products. Non-limiting examples of dishwashing products can include dishwashing detergents, rinse aids (e.g. Cascade® Complete), dish soap, and the like. In another example, the tag can be associated with a dish washer and in another example the tag can be associated with the dish washer and the dishwashing product. In one example, the reminder system can assist the user to set up a reminder that the dishwasher has completed its cycle. In another example, the reminder system can assist the user to set up a reminder that dirty pans have finished soaking in the sink The reminder system can choose the time interval similarly to how the time interval was chosen for fabric care products.

In another example, the tag can be associated with household cleaning products. Non-limiting examples of household cleaning products can include bathroom cleaners, multi-surface liquid cleaners, dusters, floor cleaners (e.g., Swiffer® Sweeper and Swiffer® wet), wood cleaners, and combinations thereof. In one example, the reminder system can assist the user to set up a reminder to perform certain cleaning tasks. In one example, the reminder system can remind the user to use multiple household cleaning products and the reminder system can remind the user to use all of the products at the same, for instance on the same day of the week and in another example, the reminder system can remind the user to perform certain cleaning on certain days so the user can clean in shorter intervals.

In another example, the tag can be associated with air freshener products. Non-limiting examples of air freshener products can include plug-in air fresheners (e.g., Febreze® NOTICEables), table top air fresheners (e.g. Febreze® Set & Refresh), scented candles, car air fresheners (e.g. Febreze® Car™ Vent Clips), and combinations thereof. In one example, the reminder system can remind the user to change or replace the air freshener product and in another example the reminder system can remind a user to turn off or blow out an air freshener product.

In another example, the tag can be associated with teeth whitening products (e.g., Crest® Whitestrips®) and can be used to set up a reminder to remove the whitening product after use. In one example, the tag can located on the wrapper of the teeth whitening product and in another example the time interval can be set automatically by the reminder system.

In another example, the tag can be associated with a toothbrush or electric toothbrush head and can be used to provide a reminder to change the toothbrush or toothbrush head. In one example the tag can be located on the container that holds the toothbrush or toothbrush head and in another example the time interval can be set automatically by the reminder system.

In one example, the tag can be associated with men's or women's razors and can be used to provide a reminder to change razor blades. In one example, the tag can be located on the container that holds the razor blades and in another example the tag can be located on the razor. In one example the time interval can be set automatically by the reminder system and in another example the time interval can be set by the user based on his or her personal preference. In another example, the reminder system can be programmed to get data from the user such as how frequency of shaving, hair thickness, and size of the area being shaved, that can help determine the appropriate time interval before the user should change the razor blade and the reminder system can recommend a time interval.

In another example, the tag can be associated with a beauty product and can be used as a reminder to use the beauty product. Non-limiting examples of beauty products could include hair serum, conditioner, shampoo including anti-dandruff shampoo, hair color, temporary hair color, face masks or scrubs, face cleansing strips, hair removal products (e.g., Olay® Smooth Finish Facial Hair Removal Duo), anti-aging products, cosmetics, and combination thereof. In one example, the tag can be associated with a beauty product that may not be used daily, such as a face mask or scrub or hair serum. In one example, the time interval for beauty products is set automatically. In another example, the reminder system can be programmed to collect data from the user to help recommend the length of time for the time interval. For instance, if a user is interested in strengthening her hair by using a hair serum the reminder system may collect data such as frequency of washing hair, hair condition, and thickness of hair. In another example, the tag can be associated with mascara and the reminder system can remind the user to switch to a new mascara after a certain amount of time, for instance, three months.

In another example, the tag can be associated with sunscreen wherein the tag can be used to set up a reminder to reapply sunscreen. In one example, the time interval can be set automatically by the reminder system and in another example the time interval can be set by the user based on his or her personal preference. In another example, the reminder system can be programmed to collect data from the user such as the time of day that the sun exposure will occur, the activities the user will be participating in, the age of the users, and the user's skin tone.

In another example, the reminder system can automatically determine the time interval based on the sun protection factor (SPF) of the product, the time of day, and the weather conditions. In another example, the user can set the time interval. In one example, the tag can be associated with medicine and can be used as a reminder to take medicine. Non-limiting examples of medicine can include OTC drugs, prescription drugs, and combinations thereof. In one example, the tag can be associated with multi-symptom relief cold/flu medication (e.g., Vicks® DayQuil® and Vicks® NyQuil®) and can be set up to remind the user to take their medication every four hours or every six hours, per the monographed dosage instructions.

In another example, the tag can be associated with a proton pump inhibitor (e.g., Prilosec® OTC). The reminder can be particularly helpful when using a proton pump inhibitor because the user takes the medication infrequently, for instance, in the case of Prilosec® OTC, the monograph directions instruct a user to take the medicine every day for 14 days and then the user is instructed to wait at least four months before repeating the 14 day treatment. Therefore, it could be useful for a user of proton pump inhibitors to have a reminder sent to them every day for 14 days to take their medication and then another reminder sent after 4 months to remind her that she can repeat the course of treatment if necessary.

In another example, the tag can be associated with vitamins and can be used to set up a reminder to take the vitamins. In one example, the user can select when she wants the reminder sent. In another example, the reminder system can assist the user in determining what vitamins are best to reach her health goals as well as determining how frequently the vitamins should be taken.

In another example, the tag can be associated with OTC drugs, vitamins, minerals, supplements, probiotics or supplements and can help the user establish a regimen. In one example the tag is associated with a fiber supplement (i.e. Metamucil®) and the user can choose how many times a day and when she wants to ingest the fiber supplement and then the reminder system can reminder her to take the fiber supplement. In another example, the tag is associated with a probiotic (i.e. Align®) and the user can choose what time of day she wants to take the probiotic and the reminder system can remind her to take a probiotic. Receiving regular reminders can help the user establish a new regimen. In addition, the reminder system can help the user track her symptom progress, for instance, at the end of each day the reminder system can ask the user a series of questions related to her symptoms and over time this can help the user determine whether the product she is using is effective.

In another example, the tag can be associated with pet products. Non-limiting examples of pet products can include pet food, pet treats, medication, supplements, and combinations thereof. In one example, the reminder system can assist the user to set up a reminder that they need to give their pet food, treats, medication, and/or supplements. In one example, the reminder system can be used to remind a user to give their pet flea, tick, and/or heartworm medicine.

In another example, the tag can be associated with diapers or adult incontinence products. In one example, the reminder system can assist the user to set up a reminder that they need to check or change a child's diaper. This reminder system can be used by any caregiver, including a parent or guardian or at a child care facility where there are numerous children who need their diapers changed. Similarly, for adult incontinence products the reminder system can assist the user to set up a reminder that they need to check or change their own adult incontinence product or someone else's adult incontinence product. In one example, this reminder system can be used in a nursing home, hospital, hospice, or other facility that cares for individuals that tend to wear adult incontinence products. The tag can be located anywhere on the diaper or the adult incontinence product. In one example, the tag can be located on the waist band and in another example the tag can be located on the tab that is used to secure the diaper or adult incontinence product.

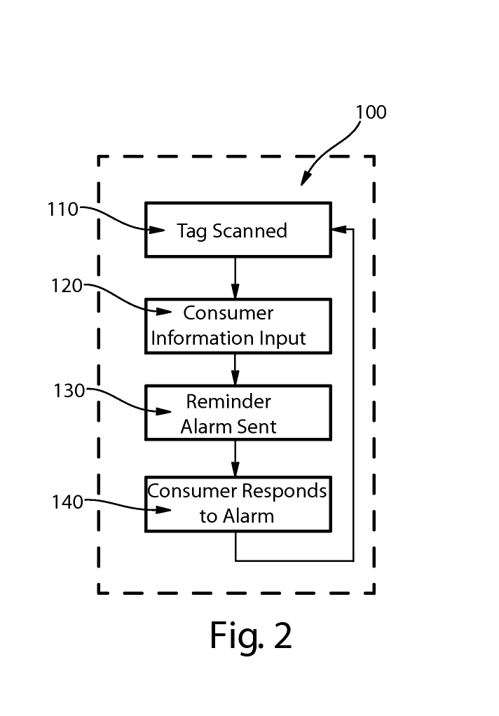

FIG. 2 shows an exemplary reminder system 100 for reminding a user to take, use, replace, or remove a consumer product. The reminder system 100 comprises the steps of; scanning a tag that is associated with a consumer product 110 with a reader device, requesting user input related to their intended use of the consumer product 120 via the mobile computing device, sending the user a reminder to take, use, replace or remove the consumer product 130 based on the consumer product type, intended use of the product, other user input, and/or safety or health parameters associated with the use of the consumer product, and the user acknowledges the reminder 140 from the mobile computing device.

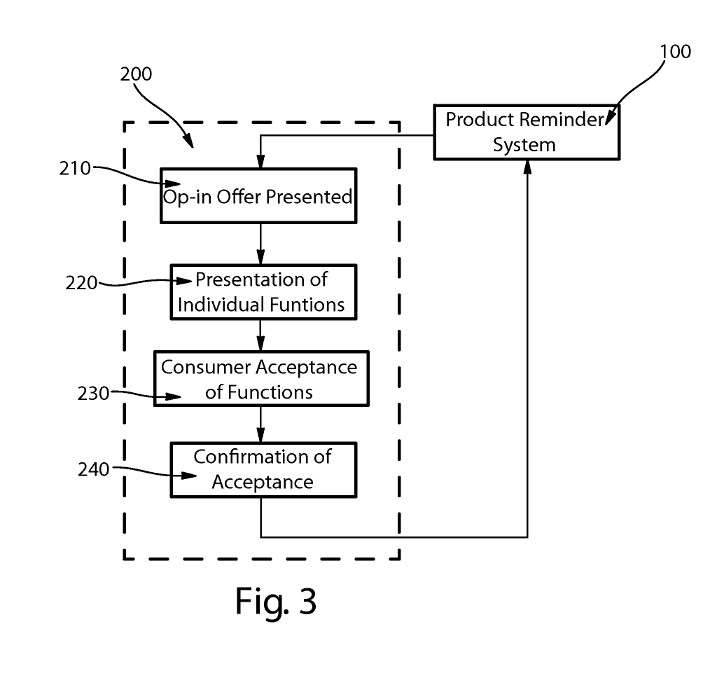

FIG. 3 shows an exemplary optional opt-in method 200 that can be inserted within the reminder system 100 or used in conjunction with the reminder system 100 the first time it is used by the user. This optional opt-in method 200 can provide the user with the opportunity to fully understand all of the functions of the reminder system 100 and agree to one or more of the functions of the reminder system 100. In one example, the optional opt-in method 200 could be presented to the user via a mobile computing device the first time the user can scan a tag proximal to a consumer product 110.

In one example, the first time the user scans a tag that is associated with a consumer product 110, the optional opt-in method 200 can be initiated. The optional opt-in method 200 comprises the steps of; presenting the user with an offer to accept using the reminder system 210, an identification of each of the significant elements of the reminder system including reminders, data collection, and data sharing features 220, a user acceptance and acknowledgement of individual and/or overall features 230 of the reminder system 100, and a confirmation of the user's acceptance 240 of each of the features of the reminder system 100.

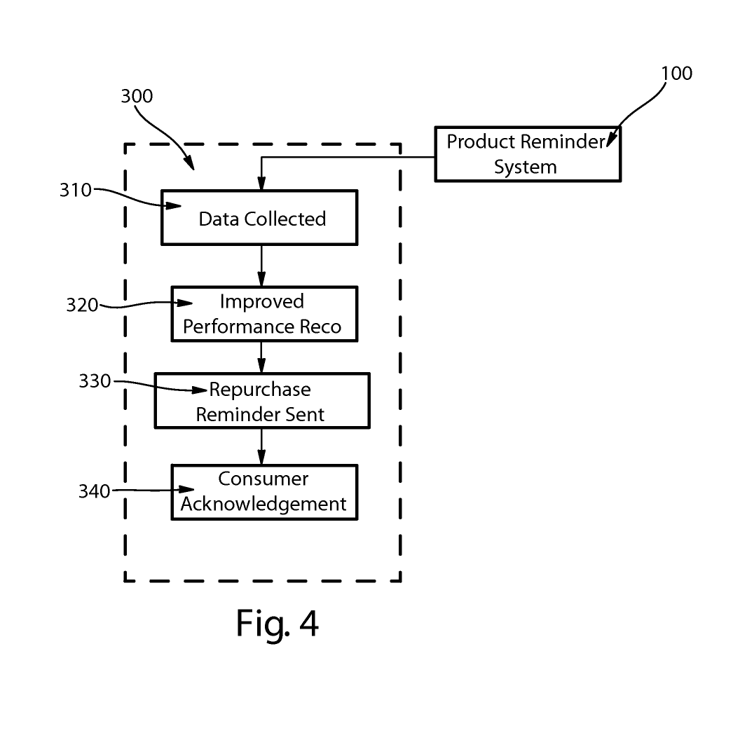

FIG. 4 shows optional steps that the reminder system 100 could perform after the user has used the method one or more times.

General examples of data 310 which can be collected include; the frequency of using, replacing, or removing a consumer product, the duration of use of the product, the total number of consumer products consumed based on the number of scans and/or through reminder confirmations, or the average lapse in time between the acknowledgement of a reminder and the next scan of a tag proximal to a consumer product.

Collected data 310 can be used to provide the user with alternative product suggestions or recommendations 320 which could provide the user with improved product performance.

Collected data 310 can also be used to send repurchase reminders 330 to the user. In order for this reminder to work accurately, the user would need to confirm a repurchase 340 has occurred and the user is starting to use product from a newly purchased package. This reminder would also be based on product information scanned during step 110 of the reminder system 100, the software can determine the number or amount of product used relative to the total amount of product within a package at any point in time, and based on the projected frequency of future use, determine when a reminder for repurchase of product 330 should be sent to the user.

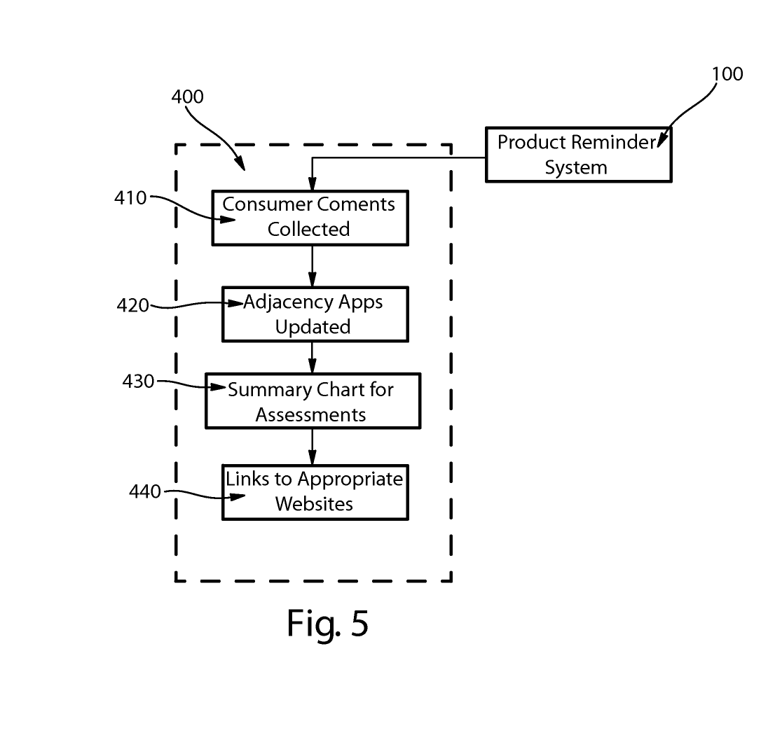

FIG. 5 shows optional steps that involve sharing of information 400 collected by the mobile computing device with other computing systems. For instance, the user may want to provide performance feedback 410 of the consumer product with the manufacturer. Performance feedback can include product usage lifetime, product failure rates or modes, product experience, recommendations for product improvements, previous products used, and combinations thereof.

The collected information can be shared with other adjacency apps 420 that have been installed on a mobile computing device. These adjacency apps can include; a shopping list app that would allow the automatic placement of the consumer product on the shopping list for repurchase when the remaining product reaches a minimum threshold value, a calendar app that can put a reminder of an upcoming event on the calendar so that the user would know the next time the product may be needed (such as a menstrual calendar predictor app), a coupon app so the user knows when the product is on sale and can repurchase the product, and the like.

Collected information can be summarized, tabulated, and/or charted 430 for sharing with others. This sharing of information can be; with health professionals such as nutritionists, dentists, disease specialists, gynecologists, family practice doctors, etc., with maintenance workers such as plumbers, electricians, roofers, etc., or with financial experts, lawn care workers, cosmetologists, and the like.

Collected information can also be used to trigger the generation of a list of appropriate websites 440 for additional information. These websites can include third party sites that specialize in subjects like childhood illnesses, women's health, teen advocacy, mental health, product performance assessments, consumer advocacy sites, cleaning tips, fitness, overall health and well being, and the like.

### Example 1

One non-limiting example is a reminder system to remind a user to take multi-symptom relief cold/flu medication, such as DayQuil® Liquicaps®. A QR code, which can be generated by Azon Media, is printed on the blister pack. The QR code can be printed in the top right hand corner of the blister card. The QR code can be scanned and decoded using a smartphone, such as an iPhone® 4S, or equivalent, available from Apple®. The smartphone can have an application, such as the NeoReader which is available from NeoMedia Technologies, that can scan and decode QR codes. After the QR code is scanned and decoded, the user will automatically be directed to a website that allows them to set up a reminder to remind them to take their multi-symptom relief cold/flu medication at regular intervals. After four hours, the user can receive notification, such as a text message, that it is time for them to take their medication. The notification can also be a visual alert that appears on the screen of the smartphone and/or it can be an audio alert.

### Example 2

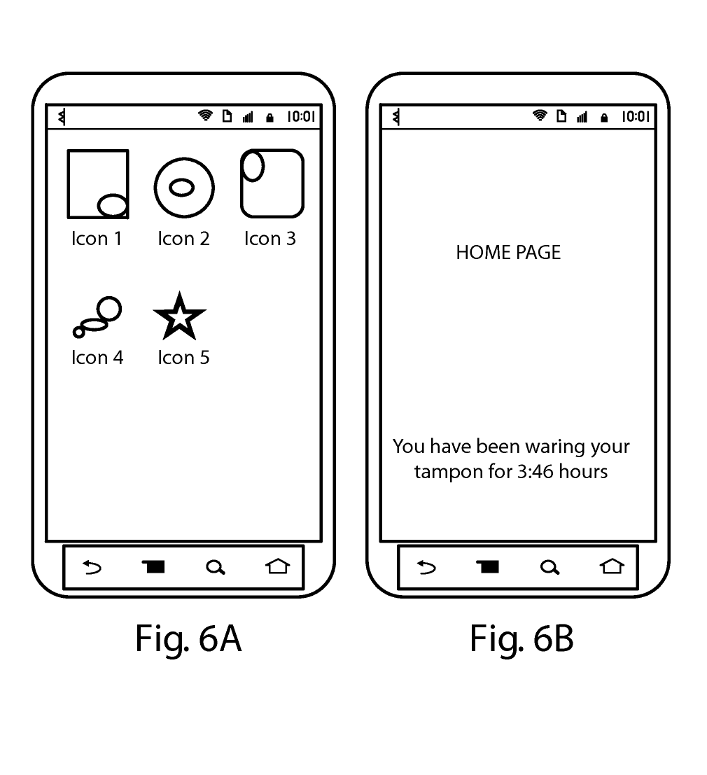

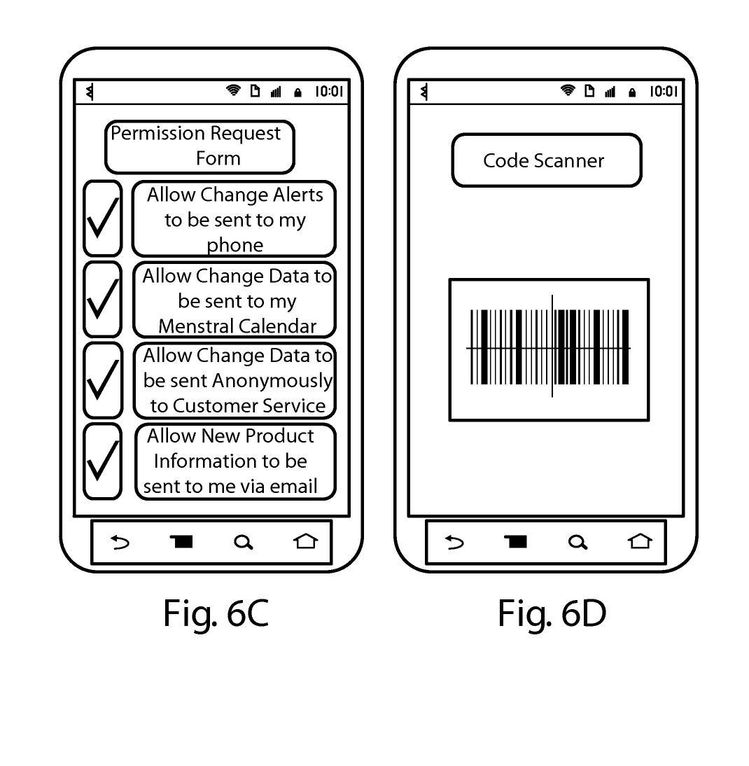

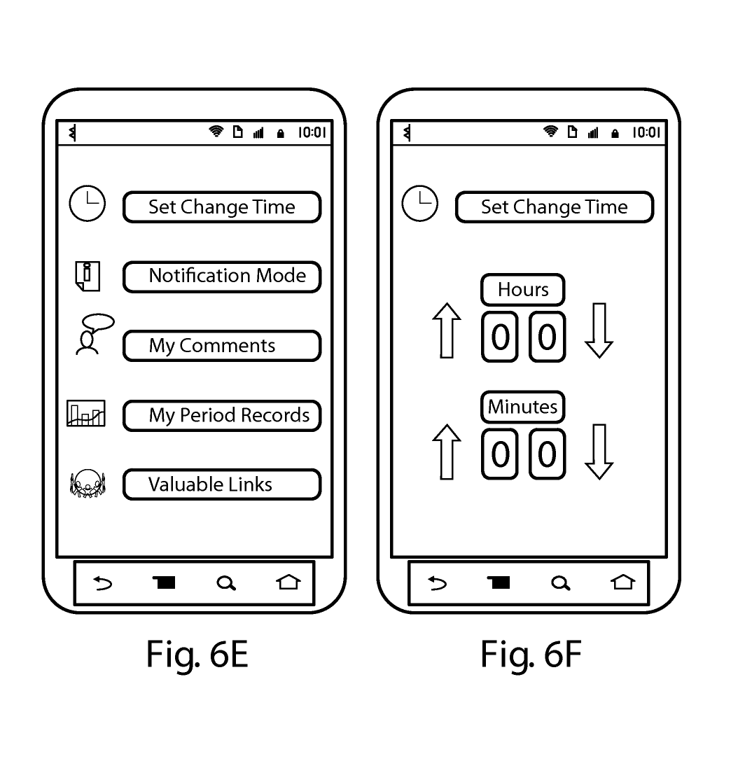

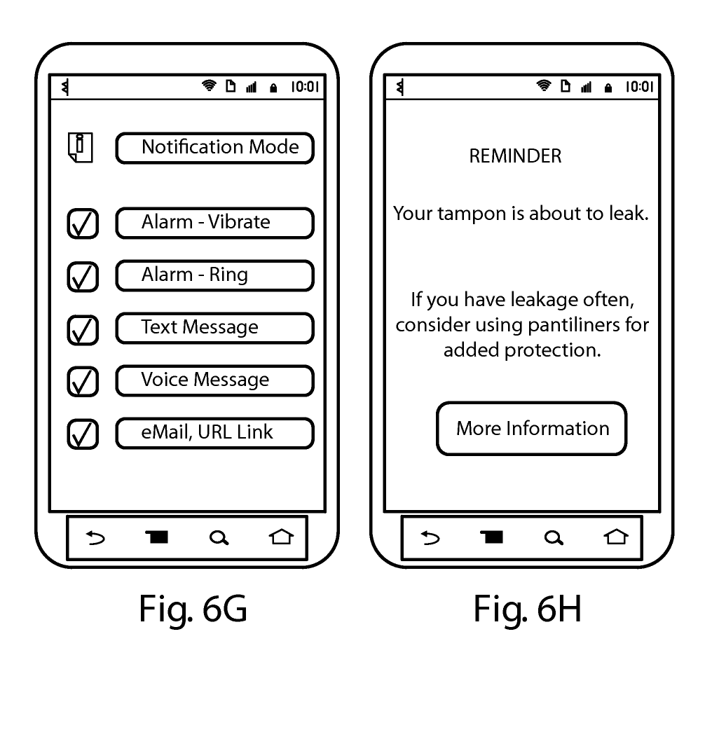

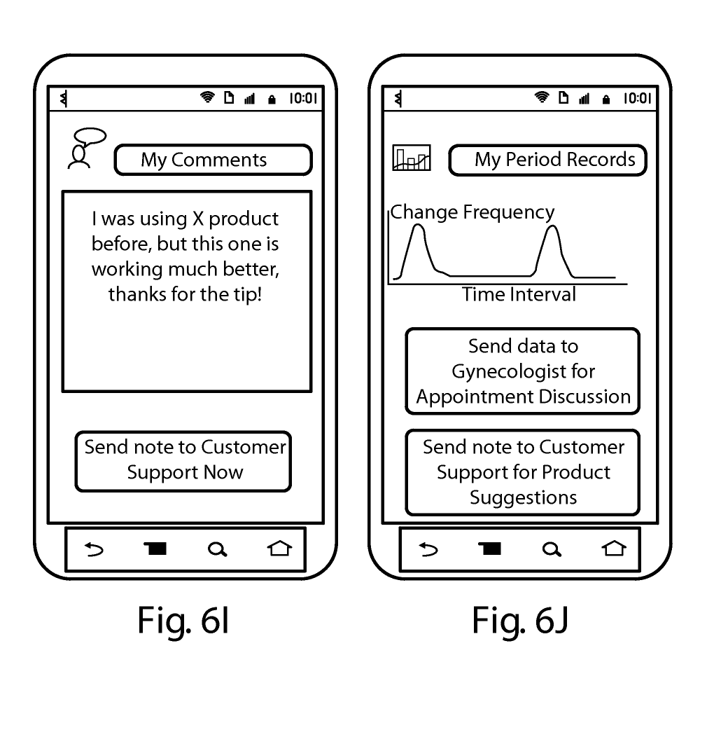

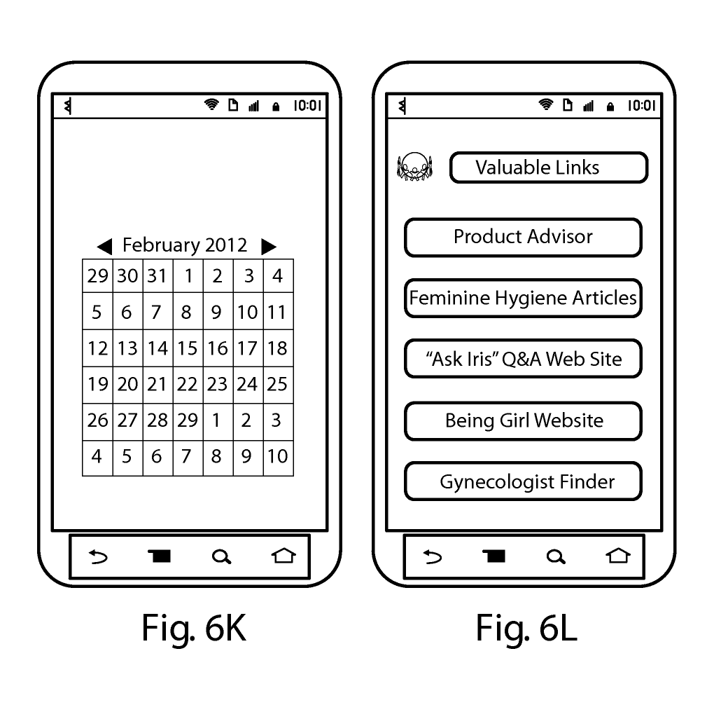

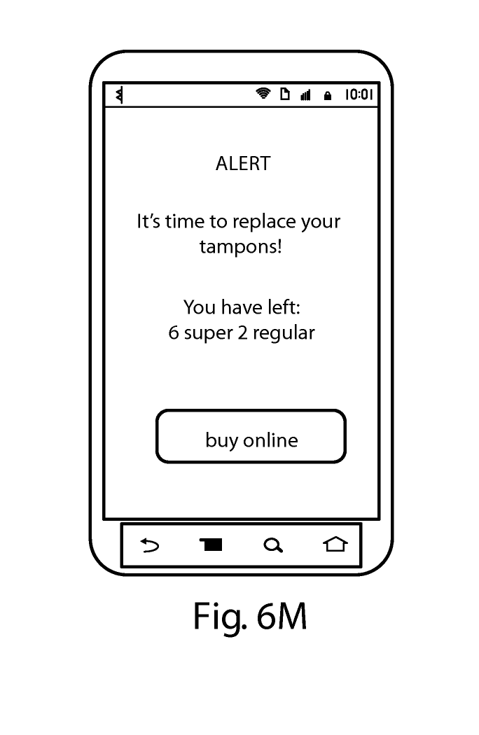

The system illustrated throughout FIG. 6A through 6M relates to a reminder system for using absorbent feminine hygiene products, and specifically to internally positioned feminine hygiene products such as tampons.

If a tampon is properly placed within the vagina, a woman can forget to change it regularly, especially when she is busy. However, these products have limited absorbency and need to be removed and/or replaced on a regular basis to prevent leaking. Near the end of a woman's menstrual cycle soiling becomes less of an issue, however the woman may forget about the product and leave it in too long. In this situation, there is an increased chance for microbial related health issues to occur, such as toxic shock syndrome. A feminine hygiene product reminder system can reduce the likelihood of leaking or inadvertent extended use of the product, thereby improving the overall performance of the product. Moreover, the reminder system can be used to facilitate improved product selection and/or improved awareness of the individual to issues associated with women's health.

Individual images shown throughout FIG. 6 represent screenshots of a mobile computing device demonstrating different elements within the system. In this example, the user has already loaded an application for the reminder system onto a mobile computing device, specifically a smart phone.

FIG. 6A represents a screenshot of a typical smart phone with various application icons shown on the front screen. In one example, to activate the reminder system, the user would touch the appropriate icon on the screen of the device and the mobile smart phone would initiate the software associated within the reminder system.

FIG. 6B represents a screenshot of the home page for the feminine hygiene reminder system. This screen can provide a welcome to the user and/or provide advertising or product information to the user.

The first time the feminine hygiene reminder system is used, an optional opt-in routine as described in FIG. 6C may appear. This representation of a screenshot for an opt-in routine can request the user's permission for a variety of features for the reminder system. For example, the user may give permission for alerts to be sent to her mobile computing device, the user may give permission to allow product usage data to be sent to a customer service site or other software applications such as a menstrual calendar, or the user may give permission for information to be sent to the her via email, text message, and/or alerts from the application.

After the user has accepted the various functionalities of the system, the feminine hygiene system can initiate a reader device as represented in FIG. 6D. The reader device can scan and decode the information in the tag.

After scanning the tag, the main navigation page for the system can appear on the mobile computing device. A representative screenshot of this page is shown in FIG. 6E. From this page, the user can select: the time of day she wants the reminder sent or the amount of time she wants to elapse before receiving a reminder; the means for how she wants to be notified; comments about the product that she wants to send to the manufacturer and/or to other users; access to data associated with her product usage and her period and potentially transfer this data to a menstrual/fertility calendar; and access to internet links for additional information on women's health.

FIG. 6F is a representative screenshot of how the user can select the time interval she wants to elapse before receiving a reminder to remove or replace the feminine hygiene product. For instance, she can select four, five or six hours to elapse. This functionality can also have a maximum allowable time interval feature, such as an eight hour limit, when the mobile computing device would automatically notify the user of the need to remove or replace the product. This functionality could be intended as an added safety feature for the user.

FIG. 6G is a representative screenshot of how the user can select the mode of notification. These features can represent various levels of discreetness as well as effectiveness depending on a user's personal preference or style. She can also have the ability to select multiple notification modes, such as having an alarm set on a mobile computing device as well as being sent a text message.

FIG. 6H is a representative screenshot showing a visual reminder to the user that it is time to change her feminine hygiene product.

As indicated in the main navigational page shown in FIG. 6E, the user can have an option to provide comments. FIG. 6I is a representative screen shot showing a page allowing the user to provide product performance feedback directly to the consumer product manufacturer. If so desired, a representative from the manufacturer can contact the user and provide additional product information, alternative product information, or promotional offers and opportunities.

One of the more concerning issues a woman may have with her period is determining whether or not it is normal. Sometimes menstrual periods can last eight or nine days, which may be abnormal. Being able to share computer generated data associated with her recent period or multiple periods to a health professional, such as a gynecologist, may be a helpful feature. FIG. 6J shows a representative screenshot of a page plotting out a user's menstrual period flow patterns based on tampon change frequency. The user can also use this feature to email the information to her gynecologist or health care providers. In one example, the user can download the information collected by the reminder system in order to later share this information with her health care provider or to keep the information in her personal records. In one example, the reminder system begins collecting information about the menstrual cycle length and how heavy the flow is, as soon as the user begins using the reminder system and stops collecting this data when the user stops using the reminder system.

The previous discussion on the main navigation page shown in FIG. 6E described the potential for menstrual flow information being transferred to a menstrual/fertility calendar. FIG. 6K shows a representative screenshot for this function. Based on the average period start, duration, and interval frequencies, the system software can predict the next likely period start date and duration, and can then forward that information to any number of menstrual/fertility calendar applications that are separately available for computing devices, including mobile computing devices.

Internet links as previously described in FIG. 6E can include links to product advisors, hygiene products, interactive Q&A sites, commercial product websites, and professional locator features. A representative screenshot of these features is shown in FIG. 6L.

Based on change frequency, the remove/replace method may recognize that the product change frequency is not consistent with the manufacturer's intended product usage. For instance, the user can be using a product with too low of an absorbency or too high of an absorbency based on her flow characteristics. If she selected the “Product Advisor” feature as shown in FIG. 6L, the method could automatically detect issues with product absorbency and suggest other products with different absorbency features.

FIG. 6M is a representative screenshot showing a simple product recommendation image based on this feature.

Values disclosed herein as ends of ranges are not to be understood as being strictly limited to the exact numerical values recited. Instead, unless otherwise specified, each numerical range is intended to mean both the recited values and any integers within the range. For example a range disclosed as “1 to 10” is intended to mean “1, 2, 3, 4, 5, 6, 7, 8, 9, 10.”

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising the steps of:
a. providing a feminine hygiene product comprising a tag associated with the product wherein the tag is decodable by a reader device;
b. providing a reminder system wherein upon decoding the tag the reminder system prompts a user to set a reminder to use, replace, or remove the feminine hygiene product.

2. The method of claim 1, wherein the tag is a QR code.

3. The method of claim 1, wherein the location of the tag is selected from the group consisting of on the consumer product, on a wrapper associated with the consumer product, on a secondary container associated with the consumer product, on an object associated with the consumer product, and combinations thereof.

4. The method of claim 1, wherein the reminder system prompts the user to set a time interval for the reminder.

5. The method of claim 1 further comprising the step of confirming using, replacing, or removing the product and wherein after confirming the method automatically repeats.

6. The method of claim 1 further comprising the step of collecting data and making a recommendation for a future use of the feminine hygiene product.

7. The method of claim 1, wherein the reminder is sent within eight hours recommending the user change the feminine hygiene product.

8. The method of claim 1, wherein the feminine hygiene product is selected from the group consisting of a pantiliner, an absorbent pad, a tampon, or a feminine incontinence product.

9. The method of claim 1, wherein the reminder system enables the user to post usage experience on social media websites.

10. The method of claim 1, wherein the method further comprises prompting the user to answer questions about the product, usage habits, and the like after each reminder.

11. The method of claim 6, wherein the data collected consists of days of individual menstrual cycle, level of flow, leakage occurrence, and comfort level.

12. The method of claim 1, further comprising the step of tracking usage patterns of individuals to create consumer preferred package with various absorbencies.

13. A reminder system comprising:
a. a feminine hygiene product comprising a tag associated with the product and/or its packaging wherein the tag is decodable by a reader device;
b. a means for setting a time interval; and
c. a means for sending a reminder after the time interval has elapsed.

14. The reminder system of claim 13, wherein the reminder system comprises a website.

15. The reminder system of claim 13, wherein the reminder system comprises an application.

16. The reminder system of claim 13, wherein the tag is a QR code.

17. The reminder system of claim 13, wherein the means for sending a reminder is selected from the group consisting of a text message, a phone call, an e-mail, a reminder from a calendar program, an alert from the reminder system, an alarm, and combinations thereof.

18. A method comprising the steps of:
a. providing a feminine hygiene product comprising a tag associated with the product wherein the tag is decodable by a reader device and provides information about the absorbency level and product form;
b. collecting data for the individual's menstrual cycle from the individual; and
c. making a recommendation for future product usage.

19. The method of claim 18, wherein the recommendation for future product usage includes the absorbency level of the future product.

20. The method of claim 18, wherein the data collected consists of days of individual menstrual cycle, level of flow, leakage occurrence, and comfort level.
